(19) United States
(12) Patent Application Publication
(10) Pub. No.: US 2011/0015966 A1
(43) Pub. Date: Jan. 20, 2011

(54) DISPLAYING DATA FOR A PHYSICAL RETAIL ENVIRONMENT ON A VIRTUAL ILLUSTRATION OF THE PHYSICAL RETAIL ENVIRONMENT

(75) Inventor: Christopher William Wasco, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: THE PROCTER & GAMBLE COMPANY, Cincinnati, OH (US)

(21) Appl. No.: 12/502,800

(22) Filed: Jul. 14, 2009

(51) Int. Cl. G06Q 10/00; G06Q 30/00; G06F 3/048

(52) U.S. Cl. 705/10; 705/28; 715/850

(57) ABSTRACT

A method of displaying sales related data for a physical retail environment that sells physical goods on a human sized electronic illustration of the physical retail environment as a virtual retail environment is disclosed. The method may display the illustration of the virtual retail environment of the physical retail environment on an electronic display. The sales related data for a plurality of product s on the electronic illustration of a virtual retail environment may be displayed. The data may be displayed in proximity to the location of the corresponding products within the store layout. Additional detail may be displayed by selecting to see more information about an aisle, a shelf, a category or any other level of detail available.

### BACKGROUND OF THE INVENTION

This Background is intended to provide the basic context of this patent application and it is not intended to describe a specific problem to be solved.

Trying to design a useful layout for a store in order to increase sales or another parameter has been a challenge. Data has been collected but applying the data to a specific store and the layout in the store in a manner that is easy to understand has been a challenge. Short of re-arranging a store, trying to usefully visualize what a store would look like and how sale might occur in the re-arranged store has not been possible, especially in a size and scale that is meaningful to a user.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of displaying sales related data for a physical retail environment that sells physical goods on an electronic illustration of the physical retail environment as a virtual retail environment is disclosed. The method may display the illustration of the virtual retail environment of the physical retail environment on an electronic display in human scale. The illustration may contain a store layout and the store layout may contain virtual store shelves, virtual aisles, virtual departments, a virtual exit, a virtual entrance and a virtual checkout location. Product categories of products for sale in the physical retail environment corresponding to the virtual reality environment may be identified. A unique location may be assigned within the store layout to each of the product. Sales-related data for a plurality of products may be identified. The sales related data for a plurality of products selected by a user may be displayed on the electronic illustration of a virtual retail environment. The data may be displayed in proximity to the location of the corresponding product category within the store layout. Additional detail may be displayed by selecting to see more information about an aisle, a shelf, a category or any other level of detail available.

### BRIEF DESCRIPTION OF THE DRAWINGS

FIG. 1 is an illustration of a computing device;

FIG. 2 is an illustration of a method of displaying sales related data for a physical retail environment that sells physical goods on an electronic illustration of the physical retail environment as a virtual retail environment;

FIG. 3 is an illustration of a method of displaying a projection of future sales data based on a revised store layout;

FIG. 4 is an illustration of a sample virtual retail environment;

FIG. 5 is an illustration of a sample virtual retail environment with additional sales detail;

FIG. 6 is an illustration of a sample re-arranged virtual retail environment;

FIG. 7 is an illustration of a sample shelf illustration;

FIG. 8 is an illustration of a sample shelf illustration with additional sales detail; and

FIG. 9 is an illustration of additional shelf detail.

### DETAILED DESCRIPTION OF THE INVENTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

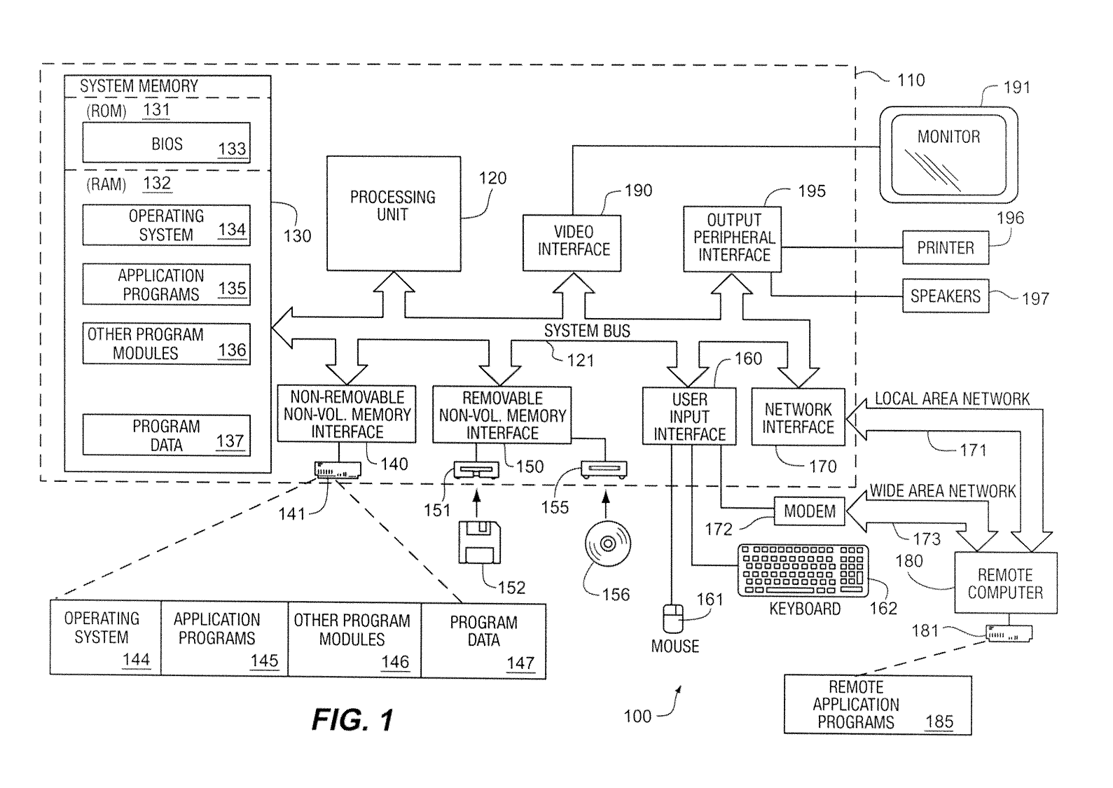

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

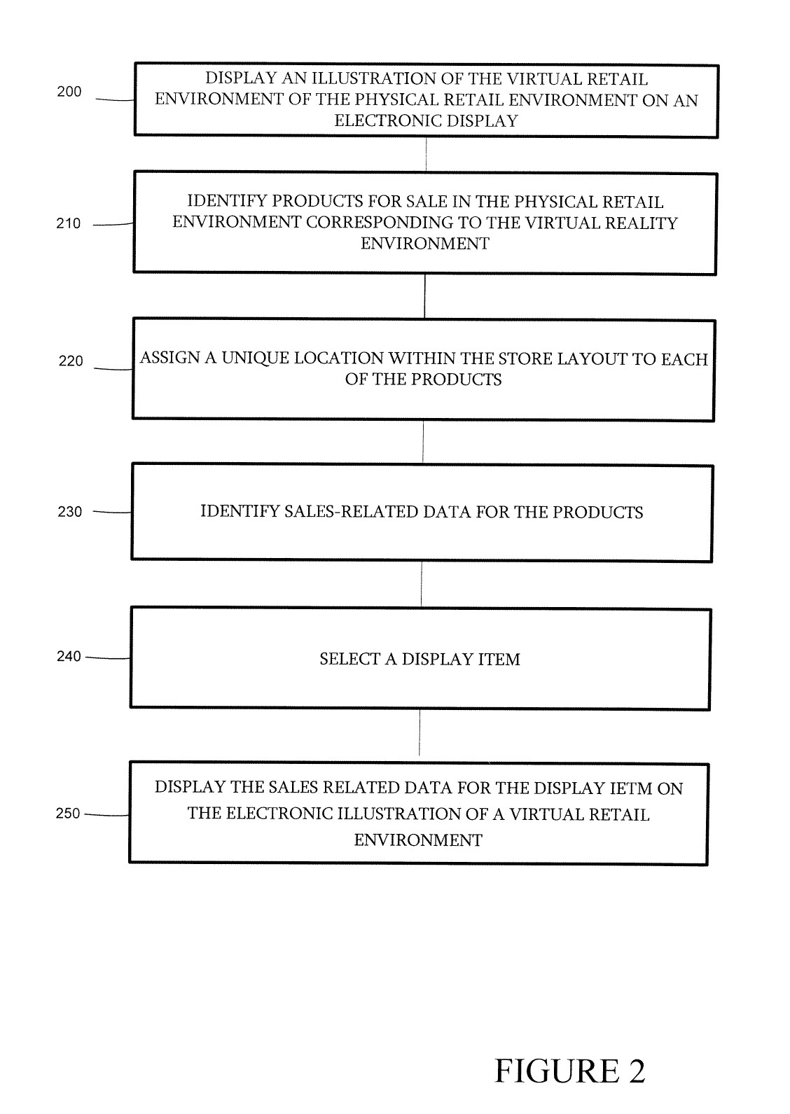

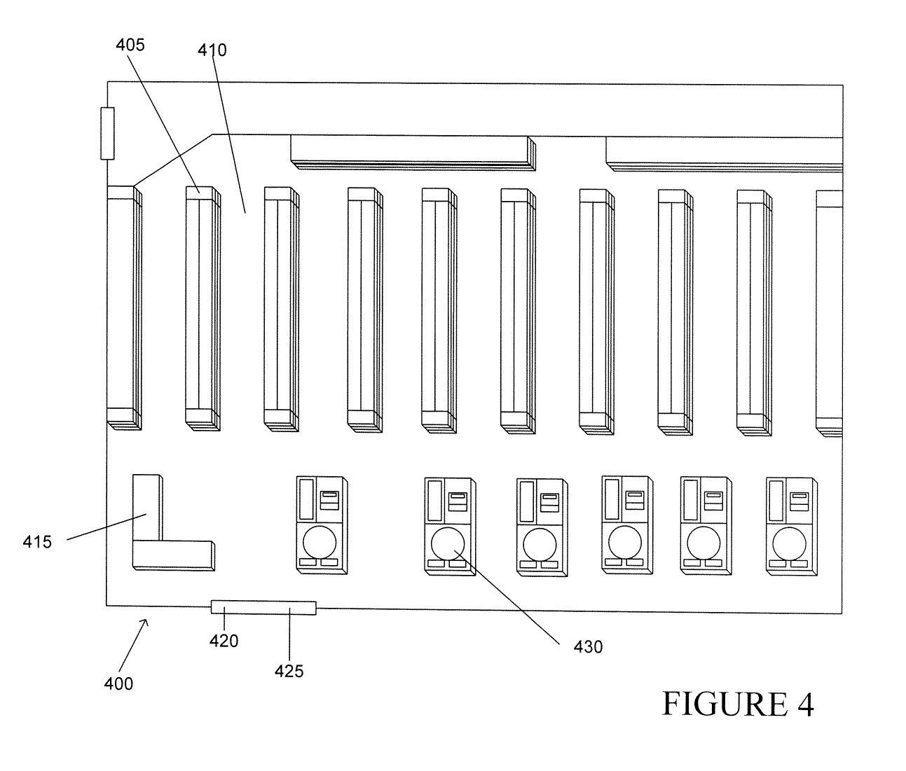

FIG. 2 illustrates a method of displaying sales related data for a physical retail environment that sells physical goods on an electronic illustration of the physical retail environment as a virtual retail environment. Attempting to visualize sales from a physical location in a store is difficult. It would be useful to have a way to more easily understand and visualize where sales and profits, for example, are coming from in a physical store can be difficult. Further, it would be useful to see how changes to a physical store environment might look without actually changing the physical environment. At the same time, it would be useful to see how current sales might be affected by a rearrangement of the physical store. FIG. 4 is a sample illustration of a virtual store.

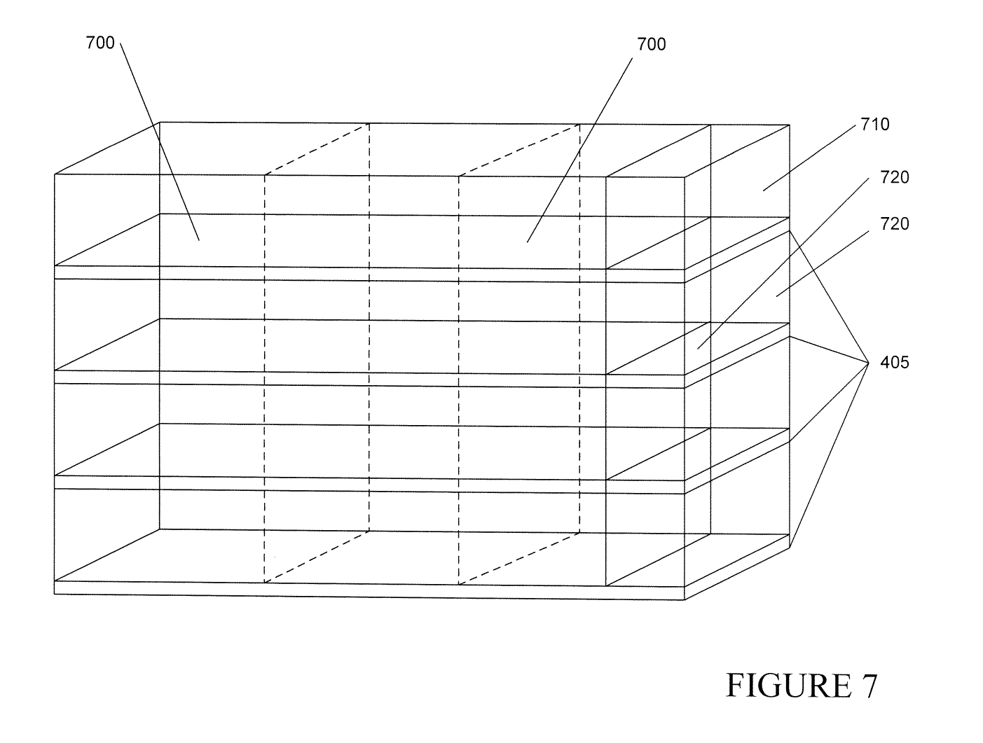

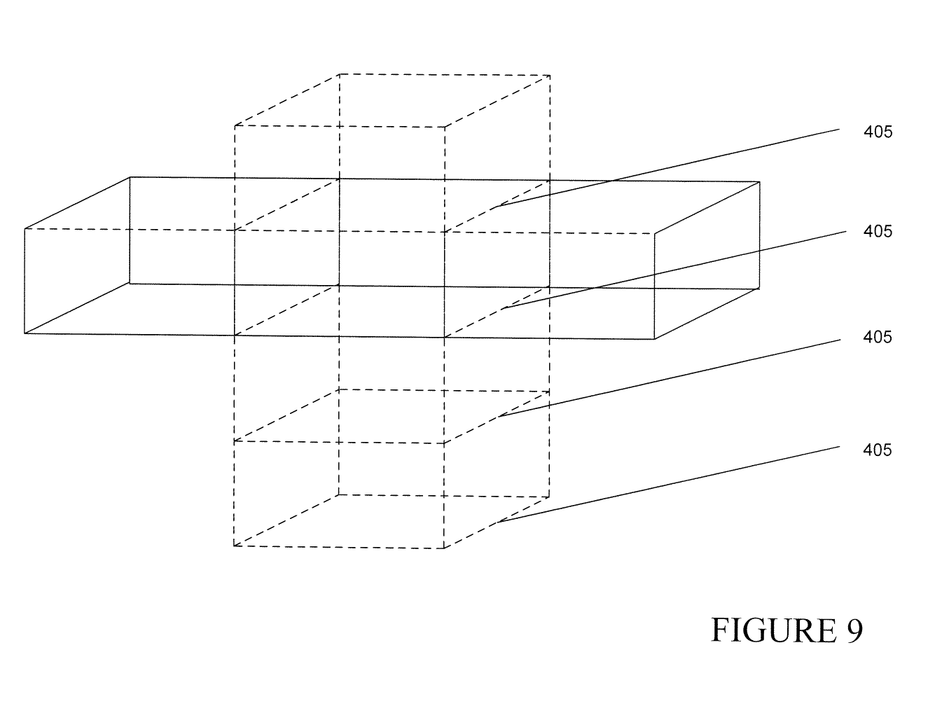

At block 200, an illustration of the virtual retail environment 400 of the physical retail environment may be displayed on an electronic display 191. FIG. 4 may be a sample illustration. The illustration 400 may include a store layout that includes by example and not limitation virtual store shelves 405, virtual aisles 410, virtual departments 415, a virtual exit 420, a virtual entrance 425, and virtual checkout locations 430. The illustration 400 may be in three dimensions and may be very graphically similar to the actual store or the illustration 400 may be a simple sketch. For example, FIG. 4 may display a store layout 400 while FIG. 7 may display a section of an aisle 410 and the individual shelves 405 on the section. FIG. 9 may be even more specific reflecting the specific placement of goods on the shelves 405. The physical retail environment may be any well known or future designed physical retail environments. The examples of physical retail environments are virtually limitless, from supermarkets to electronics stores to drug stores.

Similarly, the physical goods in the physical store may be a virtually limitless list. The physical goods likely will vary by store. The list of goods may be obtained from the specific store, from a corporate parent or from publicly available information. In addition, the goods may be brand specific or may cover a variety of brands.

The electronic display 191 may be a single traditional monitor, a plurality of monitors or a projection as long as the monitors and or projections are sufficient to display the illustration 400 on a human scale. As the price of monitors drop and size increases, and the projection technologies improves, displaying products at a human scale is possible and practical. In addition, graphics and the ability to manipulate graphics has made it possible to render extremely life-like versions of products 700 at a human scale. By human scale, the products are displayed in a size and a clarity that mimics the size and scale that would be seen in a store. The monitors or display surfaces 191 may be arranged in a surrounding manner such that a user can maneuver (step, turn around, reach, etc.) and feel as if they are in a store. For example, the displays 191 may be in a curve and a user may be able to feel as if they are walking through an aisle and can see items on shelves on each side of them and in front of them. The items may be of a scale and clarity as if they were in a store. In some embodiments, the display may be in three dimensions by using traditional three dimension techniques and three dimension glasses.

By displaying the items in a human scale, additional insights may be made. For example, the advantage of using a consistent color on products by the same supplier may be impossible to see on a traditional computer monitor. However, when seen in human scale, the ability to quickly identify and locate products from a particular supplier may be seen. In addition, by using such a large scale, data may be displayed in a manner that simply is not possible on a traditional computer monitor. For example, as the displays are so much larger than a traditional monitor, much more data may be displayed in a useful and readable form. More specifically, displaying sales data for all products 700 in the dishwasher soap category 710 may be impossible on a traditional computer monitor, but by using such a large scale, a vast amount of sale data may be across the human scale display 191.

As another example, the effect of moving a product 700 from a first shelf to a second shelf may not be fully appreciated on a typical computer monitor. But using the human scale, the effect of moving a product 700 from knee level to eye level may be striking. In addition, the product category 710, for example, may take on more meaning as competing products 700 may be seen in there true size, rather than as dots on a typical computer monitor.

At block 210, products 700 for sale in the physical retail environment may be identified corresponding to the virtual reality environment in the illustration 400. As stated previously, the products 700 for sale in the retail environment may be obtained in a variety of ways. In one example, the products for sale may be obtained from the retailer. In other embodiments the products 700 for sale are obtained from a parent or from competitive intelligence. In other embodiments, the products 700 for sale may be products that the retailer could sell but currently does not.

The products 700 may be broken down into categories 710 and the categories 710 may include product sub-categories 720. Categories 710 may be any categories 710 that are relevant to the analysis. FIG. 7 illustrates shelves 405 being separated and having categories 710, such as soap and snacks. For example, the category of snacks 710 could include pretzels and potato chips as sub-categories 720. The categories 710 may be further broken down into sub-categories 720 for specific audiences, such as name brand audiences, bargain audiences, etc. For example, name brand audiences may be interested in heavily advertised shampoo while bargain shoppers may only look for shampoos that have a price below a certain point. Of course, other sub-categories 720 are possible and are contemplated.

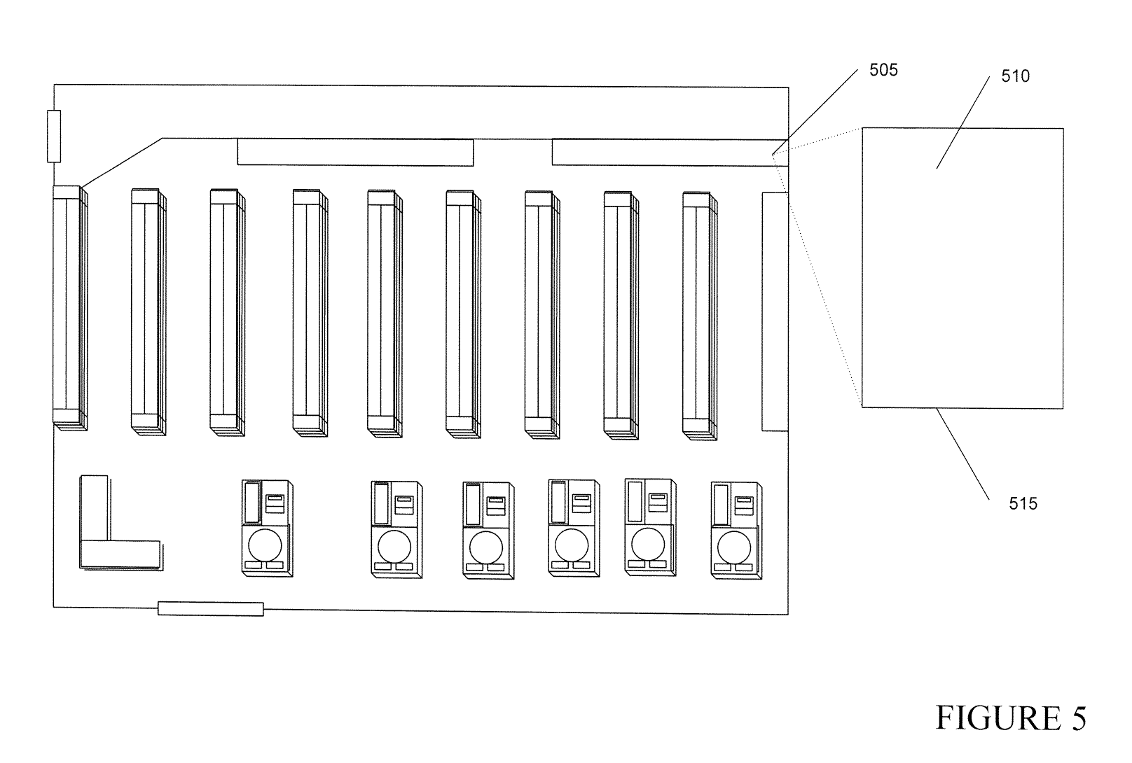

At block 220, a unique location 505 (FIG. 5) within the store layout 405 may be assigned to each of the products 700. The location 505 may be specific as a specific shelf in a specific aisle at a specific height or may be less specific, depending on the desires of the user. The unique location 505 may be adjusted, either automatically or by the user, in an attempt to maximize sales, minimize costs, maximize profits, etc.

At block 230, sales-related data 510 for a plurality of products 710 may be identified. The sales related data 510 may be the gross sales on a normalized basis or profit margin or any other relevant sales data for the products 700. Sales data 510 may also include sales data 510 for a virtual shopper category, sales data 510 for similar retailers in the same region, projected sales data 510 and sales data 510 collected using loyalty cards. For example, sales data 510 related to specific types of shampoo may be identified. The sales data 510 may be provided by the store itself, or may be provided by a parent organization or from other publicly available sources.

At block 240, a display item may be selected. The display item may be the product 700 a product category 720, the virtual store shelf 405, the virtual aisles 410 and the virtual departments 415. Of course, a combination of these items also may be selected as the display is large enough to display vast amounts of data in a meaningful way.

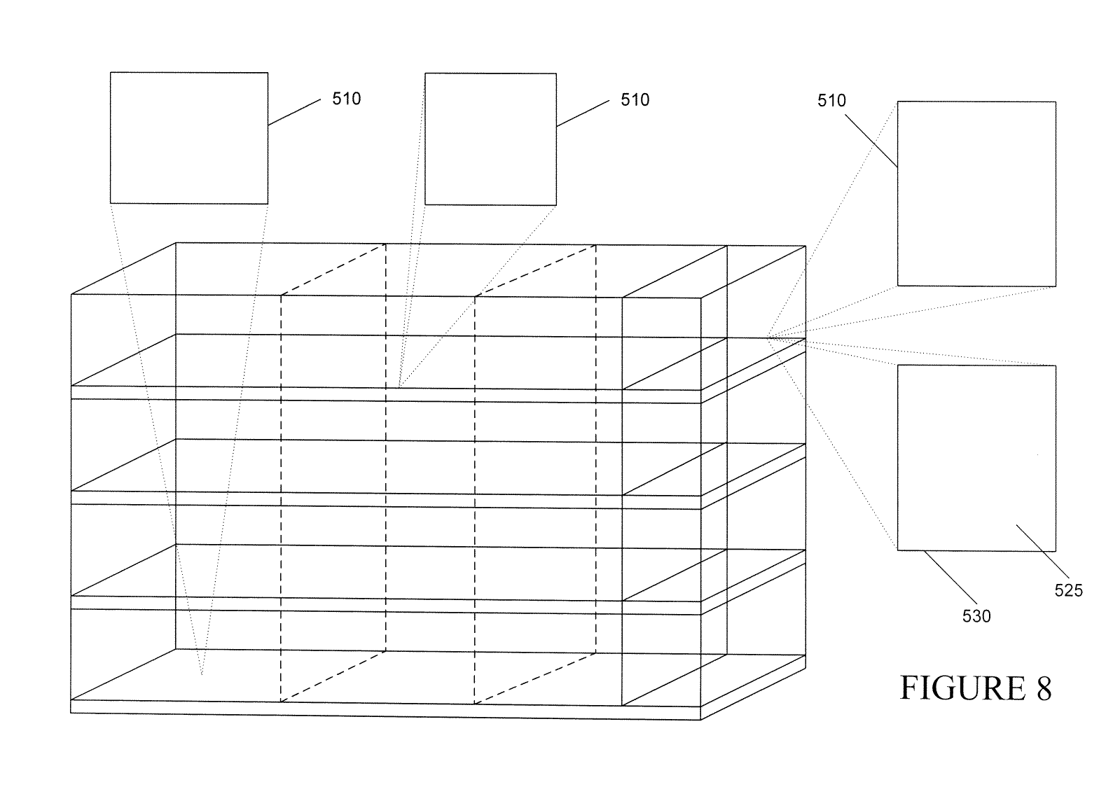

At block 250, the sales related data 510 for a plurality of products 700 may be displayed on the electronic illustration 400 of a virtual retail environment wherein the data for each product 700 is displayed in proximity to the location 505 of the corresponding product 700 within the store layout. FIG. 5 may be an illustration of sales data 510 being displayed on the illustration of the virtual environment 400. The data 510 may be displayed in a separate window 515 or may be displayed on entirely separate monitor 191. FIG. 8 may be an illustration where specific sales data 510 for a shelf 405 on an aisle 410 are displayed.

The sales related data 510 may be displayed automatically or may be selected by a user. The selection may occur in many logical manners. In some embodiments, simply rolling over a shelf 405, aisle 410 or department 415 may start the display of sales related data 510. In another embodiment, the shelf 405, aisle 410 or department 415 must be selected such as by clicking a mouse or tapping a display 191. In some embodiments, the areas that may be selected may be highlighted or indicated in any other reasonable manner. Of course, other embodiments are possible and are contemplated.

The type of sales data 510 may have a default value or may be selected by a user. For example, a default value may be to display total sales for a category 700 and a user may be able to select to see profit data, growth data, etc. In addition, a user may be able to create a specific query and the sales data 510 may be retrieved and displayed on the virtual illustration 400. The query may be made using a separate display or may be retrieved from another application. By way of example and not limitation, the sales data 510 may also include customer traffic data where customer traffic data may include how many people pass the location and how long customers stay in an area, etc.

The electronic illustration 400 may be adjusted to display sales data only about specific products 700 or categories 710. For example, sales data 400 may first be displayed for shampoo and then sales data 510 may be displayed for toothpaste. In addition, the sales data 510 may be further refine by customer type such as name brand shoppers, bargain shoppers, etc. Further, the display 400 may be adjusted for sale profit, sales volume or sales growth. For example, items that have a sales profit of at least 20% may be displayed, then items that have a sales profit less than 20% but greater than 15% may be displayed. In yet another embodiment, each of the different groups may be displayed using a different color to further differentiate between categories 710, sub-categories 720, etc. The data may be overlaid on the electronic illustration of the virtual retail environment 400 and each of the different colors may be selected to display more specific information about the group selected.

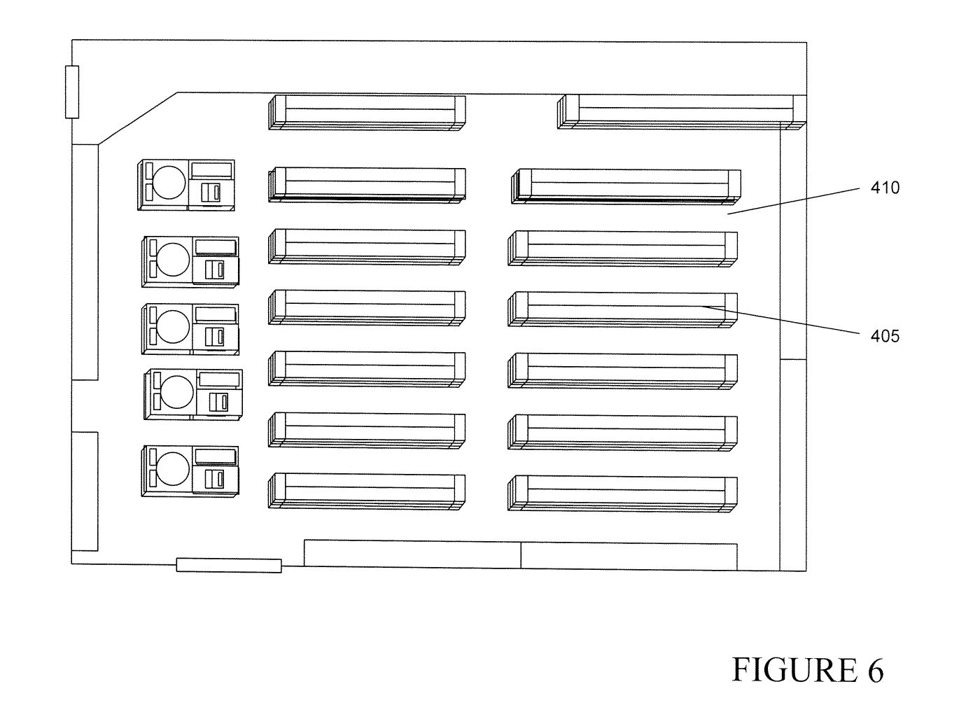

In some embodiments, the store layout may be re-arranged to illustrate different locations for the product categories 700 in different store layouts. FIG. 6 is one illustration where the same footprint of a physical store in FIGS. 4 and 5 is reconfigured. Similar to FIG. 5, additional sales data 510 may be displayed over the new store layout. The sales data 510 may be actual data or projected sales data. The display may include a before and after illustration that shows sales using the current configuration and sales in an after configuration.

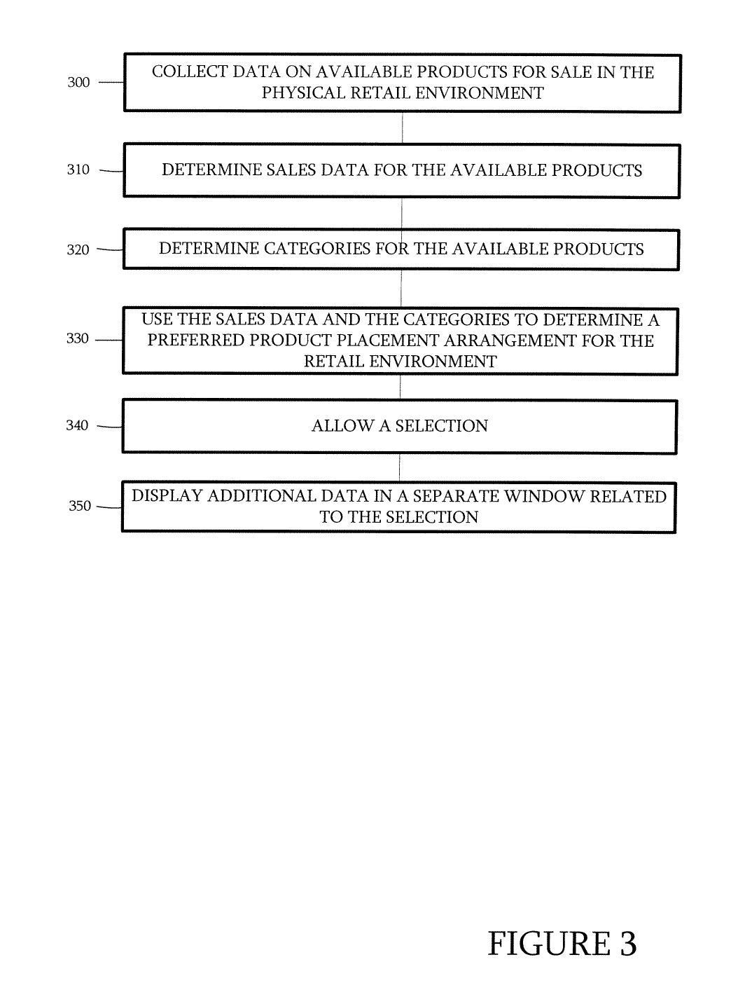

The display may also project sales data 510 that may occur if the arrangement of the store layout is adjusted. FIG. 3 may illustrate one possible method for displaying a projection of future sales data based on a revised store layout. At block 300, data may be collected on available products for sale in the physical retail environment. This data may be the same data as used in FIG. 2. The data may be sales data 510 from the specific store, may be proprietary data or may be based on publicly available data. Available products 700 may also include products 700 that logically could be sold in the physical location but currently are not.

At block 310, sales data 510 may be determined for the available products 700. As available products 700 may include products 700 that are currently not for sale, projections may be made of future sales. The projections may be made in a variety of ways. For example, the projections may be made using similar stores in the area or using stores with similar demographic data. Any logical manner of projecting sales would be sufficient.

At block 320, categories 710 may be determined for the available products 700. Again, the categories 710 could be a wide range of classifications. For example, the products 700 could be split at a high level such as products 700 for inside the home and products 700 for outside the home. Other classifications may be more specific such as brands of shampoo. Again, the brands may also be separated by the categories 710 of buyer such as name brand buyers, bargain buyers, etc

At block 330, the sales data 510 and the categories 710 may be used to determine a preferred product 700 placement arrangement for the retail environment by placing available products on virtual shelves in virtual departments in the virtual retail environment 400. The determination of the preferred product placement may be determined in a variety of ways using a variety of algorithms, all of which may be selected and modified by a user. In one embodiment, assigning a preferred location 505 may entail determining traffic patterns in the store, determining layout and adjacency parameters and using an algorithm to maximize a parameter. Sample parameters may include sales volume, sales margin and sales growth. The preferred location 505 also may be shopper-type specific.

At block 340, a selection may occur. The selection may be an available product 700, virtual shelf or virtual department or any other relevant aggregation. At block 350, additional data 525 may be displayed in a separate window 530 related to the selection. Additional data may include sales growth, sales decline, sale margin and sales gross. Other additional data are possible and are contemplated.

Color or other visual aides may also be used to indicate a variety of useful information. In one embodiment, the selection from block 340 may be highlighted using a separate color shade. In another embodiment, color may be used to highlight areas of interest to different consumers, such as highlighting products for value shoppers in red and products for name brand shoppers in blue. Of course, other visual aides to draw the attention of a user such as causing displayed elements to flash, to be outlined, to have shadows, etc.

The store layout may be toggled between a first store layout (FIG. 4) and a second store layout (FIG. 6). In this way, proposed changes to the physical layout may be imagined and the resulting change in sales may also be projected. In some embodiments, the first layout may be in a first color and the second layout may be in a second color and the layouts may be displayed over each other. Of course, other manners of toggling between the first and second layouts are possible.

In conclusion, the dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention.

Further, to the extent that any meaning or definition of a term in this document conflicts with any meaning or definition of the same term in a document incorporated by reference, the meaning or definition assigned to that term in this document shall govern. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of displaying sales related data for a physical retail environment that sells physical goods on an electronic illustration of the physical retail environment as a virtual retail environment comprising:
displaying the electronic illustration of the virtual retail environment of the physical retail environment on an electronic display in human scale that partially surrounds a user wherein the electronic illustration comprises a store layout of at least one from a group comprising:
virtual store shelves, virtual aisles, virtual departments, a virtual exit, a virtual entrance, and a virtual checkout location;
identifying products for sale in the physical retail environment corresponding to the virtual retail environment;
assigning a unique location within the store layout to each of the products;
identifying sales related data for the products for sale;
selecting a display item wherein the display item is at least one from a group comprising:
the product; a product category; the virtual store shelf; the virtual aisles and the virtual departments; customer traffic data
displaying the sales related data for the display item on the electronic illustration of the virtual retail environment wherein the sales related data for the display item is displayed in proximity to the unique location of a corresponding product of the display item within the store layout.

2. The method of claim 1, wherein the products belong to product categories and the product categories further comprise product sub-categories.

3. The method of claim 1, further comprising re-arranging the store layout to illustrate different locations for the products in different store layouts.

4. The method of claim 2, wherein the electronic illustration of the virtual retail environment is adjusted for different categories.

5. The method of claim 1, wherein the electronic illustration of the virtual retail environment is adjusted to display a selection of sales related data.

6. The method of claim 1, wherein sales related data further comprises the customer traffic data wherein the customer traffic data further comprises how many people pass a physical location and how long customers stay in an area.

7. The method of claim 1, wherein different types of shoppers may be overlaid over on the electronic illustration of the virtual retail environment.

8. The method of claim 1, further comprising:
collecting data on available products for sale in the physical retail environment;
determining sales data for the available products;
determining categories for the available products;
using the sales data and the product categories, determining a preferred product placement arrangement for the store layout comprising placing the available products on virtual shelves in virtual departments;
selecting a selection wherein the selection is at least one selected from a group comprising: an available product, virtual shelf and virtual department; and
displaying additional data in a separate window related to the selection.

9. The method of claim 8, wherein the available products further comprises the products currently sold in the physical retail environment and the products that could be added to the physical retail environment.

10. The method of claim 8, wherein sales data further comprises at least one selected from a group comprising:
sales data for the store layout;
sales data for a virtual shopper category;
sales data for similar retailers in the same region;
projected sales data; and
sales data collected using loyalty cards.

11. The method of claim 8, wherein the additional data comprises sales growth, sales decline, sale margin and sales gross.

12. The method of claim 8, wherein assigning a preferred location further comprises:
determining traffic patterns in the physical retail environment;
determining layout and adjacency parameters; and
using an algorithm to maximize a parameter wherein the parameter is one selected from a group comprising:
sales volume;
sales margin; and
sales growth.

13. The method of claim 8, wherein the store layout may be toggled between a first store layout and a second store layout.

14. The method of claim 9, wherein the electronic illustration of the virtual retail environment may be of at least one selected from a group comprising: a shelf level, an aisle level, and a store level.

15. A computer system comprising:
a processor physically configured according to computer executable instructions for displaying sales related data for a physical retail environment that sells physical goods on an electronic illustration of the physical retail environment as a virtual retail environment,
a memory for assisting the processor,
an electronic display configured to display computer images in a human scale created according to the computer executable instructions and
an user input interface,
the computer executable instructions comprising computer executable instructions for
displaying the electronic illustration of the virtual retail environment of the physical retail environment on the electronic display in human scale that partially surrounds a user wherein the electronic illustration comprises a store layout of at least one from a group comprising:
virtual store shelves, virtual aisles, virtual departments, a virtual exit, a virtual entrance, and a virtual checkout location;
identifying product for sale in the physical retail environment corresponding to the virtual retail environment;
assigning a unique location within the store layout to each of the products;
selecting a display item wherein the display item is at least one from a group comprising:
the product; a product category; the virtual store shelf; the virtual aisles and the virtual departments;
identifying sales-related data for the display item; and
displaying on the electronic display the sales related data for the display item on the electronic illustration of a virtual store layout wherein the sales related data for each of the display items is displayed in proximity to the unique location of a corresponding product within the store layout.

16. The computer system of claim 15, further comprising computer executable instructions for classifying the products into categories and overlaying different product categories or types of shoppers on the electronic illustration of the virtual retail environment.

17. The computer system of claim 15, further comprising computer executable instructions for:
collecting data on available products for sale in the physical retail environment;
determining sales data for the available products;
determining categories for the available products;
using the sales data and the categories, determining a preferred product placement arrangement for the store layout comprising placing the available products on virtual shelves in virtual departments;
selecting a selection wherein the selection is one selected from a group comprising an available product, virtual shelf or virtual department; and
displaying additional data in a separate window related to the selection.

18. The computer system of claim 16, wherein determining a preferred location further comprises computer executable instructions for:
determining traffic patterns in the physical retail environment;
determining layout and adjacency parameters; and
using an algorithm to maximize a parameter wherein the parameter is one selected from a group comprising:
sales volume;
sales margin; and
sales growth.

19. A computer storage medium comprising computer executable instructions for displaying sales related data for a physical retail environment that sells physical goods on an electronic illustration of the physical retail environment as a virtual retail environment on an electronic display, the computer executable instructions comprising computer executable instructions for
displaying the electronic illustration of the virtual retail environment of the physical retail environment on the electronic display in human scale that partially surrounds a user wherein the electronic illustration comprises a store layout of at least one from a group comprising:
virtual store shelves, virtual aisles, virtual departments, a virtual exit, a virtual entrance, and a virtual checkout location;
identifying a product for sale in the physical retail environment corresponding to the virtual retail environment;
assigning a unique location within the store layout to the product;
selecting a display item wherein the display item is at least one from a group comprising:
the product; a product category; the virtual store shelf; the virtual aisles and the virtual departments;
identifying sales-related data for the display item;
displaying on the electronic display the sales related data for the display item on the electronic illustration of the virtual retail environment wherein the sales related data for each category is displayed in proximity to the unique location of a corresponding product within the store layout; and
if selected, overlaying different product categories or types of shoppers on the electronic illustration of the virtual retail environment.

20. The computer storage medium of claim 19, further comprising computer executable instructions for:
collecting data on available products for sale in the physical retail environment;
determining sales data for the available products;
determining categories for the available products;
using the sales data and the categories, determining a preferred product placement arrangement for the store layout comprising placing the available products on virtual shelves in virtual departments wherein determining a preferred location further comprises computer executable instructions for:
determining traffic patterns in the physical retail environment;
determining layout and adjacency parameters; and
using an algorithm to maximize a parameter wherein the parameter is one selected from a group comprising:
sales volume;
sales margin; and
sales growth.;
selecting a selection wherein the selection is one selected from a group comprising an available product, virtual shelf or virtual department; and
displaying additional data in a separate window related to the selection.
